(19) United States
(12) Patent Application Publication
(10) Pub. No.: US 2024/0127104 A1
(43) Pub. Date: Apr. 18, 2024

(54) INFORMATION RETRIEVAL SYSTEMS AND METHODS WITH GRANULARITY-AWARE ADAPTORS FOR SOLVING MULTIPLE DIFFERENT TASKS

(71) Applicant: NAVER CORPORATION, Gyeonggi-do (KR)

(72) Inventors: Ioannis KALANTIDIS, Grenoble (FR); Jon ALMAZAN, Castellon (ES); Geonmo GU, Gyeonggi-do (KR); Byungsoo KO, Gyeonggi-do (KR); Diane LARLUS, La Tronche (FR)

(73) Assignee: NAVER CORPORATION, Gyeonggi-do (KR)

(21) Appl. No.: 17/959,613

(22) Filed: Oct. 4, 2022

(51) Int. Cl. G06N 20/00

(52) U.S. Cl. CPC G06N 20/00

(57) ABSTRACT

An information retrieval training system includes: a training dataset including training data having a feature space; the training data including multiple different types of elements, wherein no labels are provided with the training data; a training module configured to: maintain fixed a pre-trained model configured to receive features of queries; learn sets of pseudo-labels based on the training data; train parameters of adaptor modules for each of the sets of pseudo-labels, respectively, the adaptor modules configured to receive outputs of the pre-trained model, respectively; and train parameters of fusion modules based on neighboring pairs of the training data, the fusion modules configured to fuse together outputs of the adaptor modules, respectively.

### FIELD

The present disclosure relates to search systems and methods and more particularly to information retrieval systems and methods for performing searching in multiple different domains without using different models for each domain.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Use of computers, smartphones, and other Internet-connected devices has grown exponentially. Users utilize Internet-connected devices for many different tasks. For example, a user may utilize an Internet-connected device to search for local businesses, such as restaurants. As another example, a user may utilize an Internet-connected device to obtain directions to navigate to a desired location. As yet another example, a user may utilize an Internet-connected device to perform one or more building related functions, such as turn on a light within a building, adjust heating or cooling of a building, or open or close a garage door. As yet another example, a user may utilize an Internet-connected device to search for information on a topic, place an order, etc.

### SUMMARY

In a feature, an information retrieval training system includes: a training dataset including training data having a feature space; the training data including multiple different types of elements, wherein no labels are provided with the training data; a training module configured to: maintain fixed a pre-trained model configured to receive features of queries; learn sets of pseudo-labels based on the training data; train parameters of adaptor modules for each of the sets of pseudo-labels, respectively, the adaptor modules configured to receive outputs of the pre-trained model, respectively; and train parameters of fusion modules based on neighboring pairs of the training data, the fusion modules configured to fuse together outputs of the adaptor modules, respectively.

In further features, the training module is configured to train the parameters of the fusion modules after training the parameters of the adaptor modules.

In further features, the adaptor modules are appended to layers, respectively, of the pre-trained model.

In further features, the pre-trained model has the transformer architecture.

In further features, the pre-trained model includes a convolutional neural network.

In further features, the pre-trained model includes multiple layers, each layer including a multi head self attention (MSA) module and a multi layer perceptron (MLP) module.

In further features, the adaptor modules each include a gaussian error linear unit (geLU) and a multi layer perceptron (MLP) module.

In further features, the fusion modules each include an average pooling module that averages the outputs of the adaptor modules.

In further features, the training module is configured to determine the sets of pseudo-labels using k-means clustering.

In further features, the training module configured to determine the sets of pseudo-labels based on clustering a set of features of the training data into centroids.

In further features, the training module is configured to train the parameters of the adaptor modules based on minimizing a norm softmax loss.

In further features, the training module is configured to train the parameters of the fusion modules based on minimizing a Barlow Twins loss.

In further features, a test adaptation module is configured to selectively adjust weights of the fusion modules based on search results determined based on the model, the fusion modules, and the adaptor modules based on test data.

In further features, the test adaptation module is configured to selectively adjust the weights of the fusion modules based on a closest k number the search results to the test data, where k is an integer greater than one.

In further features, the test adaptation module is configured to set the weights of the fusion modules based on pseudo-labels for the closest k number of the search results.

In further features, the test adaptation module is configured to set the weights of the fusion modules based on determinations of whether the pseudo-labels of pairs of the search results in the closest k number of the search results are the same.

In further features, the test adaptation module is configured to set the weights of the fusion modules based on features determined by a last one of the adaptation modules and input to a last one of the fusion modules.

In further features, the test adaptation module is configured to set the weights of P number of the fusion modules to non-zero values, where P is an integer greater than or equal to one, and to set the weights of the remainder of the fusion modules to zero.

In further features, the pseudo-labels partition the feature space at different levels of pseudo-granularity, each partition of the feature space corresponding to a different set of pseudo-labels in the sets of pseudo-labels, and each adaptor module corresponding to one of the different levels of pseudo-granularity.

In further features, the training data is image training data, the queries are query images, the test data is a test image, the elements of training data are objects of image training data.

In a feature, an information retrieval system includes: a features module configured to receive a query and generate features based on the query; a model configured to generate model outputs based on the features, respectively; adaptor modules configured to generate adaptor module outputs based on the model outputs, respectively, the adaptor modules including parameters trained based on sets of pseudo-labels determined based on unlabeled training data having a feature space; a fusion module configured to generate a fusion module output based on the adaptor module outputs, the fusion module including parameters trained based on neighboring pairs of the training data; and a search module configured to, based on the fusion module output, determine a closest one or more search results to the query.

In further features, the pseudo-labels partition the feature space at different levels of pseudo-granularity, each partition of the feature space corresponding to a different set of pseudo-labels in the sets of pseudo-labels, and each adaptor module corresponding to one of the different levels of pseudo-granularity.

In further features, the training data is image training data, the query is a query image and the search results include a closest one or more images to the query image.

In a feature, an information retrieval method includes: receiving a query; generating features based on the query; by a model, generating model outputs based on the features, respectively; by adaptor modules including parameters trained based on sets of pseudo-labels determined based on unlabeled training data having a feature space, generating adaptor module outputs based on the model outputs, respectively; by a fusion module including parameters trained based on neighboring pairs of the training data, generating a fusion module output based on the adaptor module outputs; and based on the fusion module output, determining a closest one or more search results to the query.

In further features, the pseudo-labels partition the feature space at different levels of pseudo-granularity, each partition of the feature space corresponding to a different set of pseudo-labels in the sets of pseudo-labels, and each of the adaptor modules corresponding to one of the different levels of pseudo-granularity.

In further features, the training data is image training data, the query is a query image and the search results include a closest one or more images to the query image.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 includes a functional block diagram of an example environment including a search system configured to provide search results in response to queries;

FIG. 2 includes a functional block diagram including an example implementation of a search module of the search system;

FIG. 3 includes a flowchart depicting an example method of receiving a search query and providing a response to the search query;

FIG. 4 is a functional block diagram of an example implementation of a navigating robot;

FIGS. 5A-5B are a functional block diagram of an example implementation of a results module;

FIGS. 6 and 7 are functional block diagrams of an example training system;

FIG. 8 is a functional block diagram of an example architecture for the results module;

FIG. 9 is a flowchart depicting an example method of training the results module; and

FIG. 10 illustrates two different query images being input to the model of the present application [symbol] and a different model (DINO) and search results from the two different models.

In the drawings, reference numbers may be reused to identify similar and/or identical elements.

### DETAILED DESCRIPTION

The information retrieval systems and methods described in the present disclosure will be described for image retrieval. However, the present application is applicable to other forms of information retrieval, such as textual data retrieval, multi-modal data retrieval, and other types of information retrieval. The data may include multiple elements such as objects in the case of image data.

Image searching involves receiving search query including an image and identifying one or more closest images to the image of the search query. Well performing image search models can be trained for a specific domain/task based on images and associated labels for that domain/task. For example, an image search model can be trained to perform image searches for images of dog breeds based on images of dogs and associated labels of the breed of the dogs in the images. Such models, however, may not perform well for other domains/tasks without additional training. For example, a model trained based on images of dogs and associated labels may not perform well for image searching for vehicles.

The present application involves creating and training a model to search for images (or other types of information) in multiple different domains/tasks based on training images that do not include labels for the images for multiple different image retrieval tasks. A pre-trained model (e.g., a foundation mode) may be extended with independently trained sets of adaptors that use pseudo-label sets of different sizes, effectively mimicking different pseudo-granularities. All adaptor sets may be reconciled into a single unified model that performs well for multiple different retrieval tasks by training fusion layers that are guided by propagating pseudo-granularity attentions across neighboring images in the feature space of the training dataset. The adaptor weights are trained while the pretrained model is fixed. Different sets of adaptors are trained where each set of adaptors is tailored to one specific granularity.

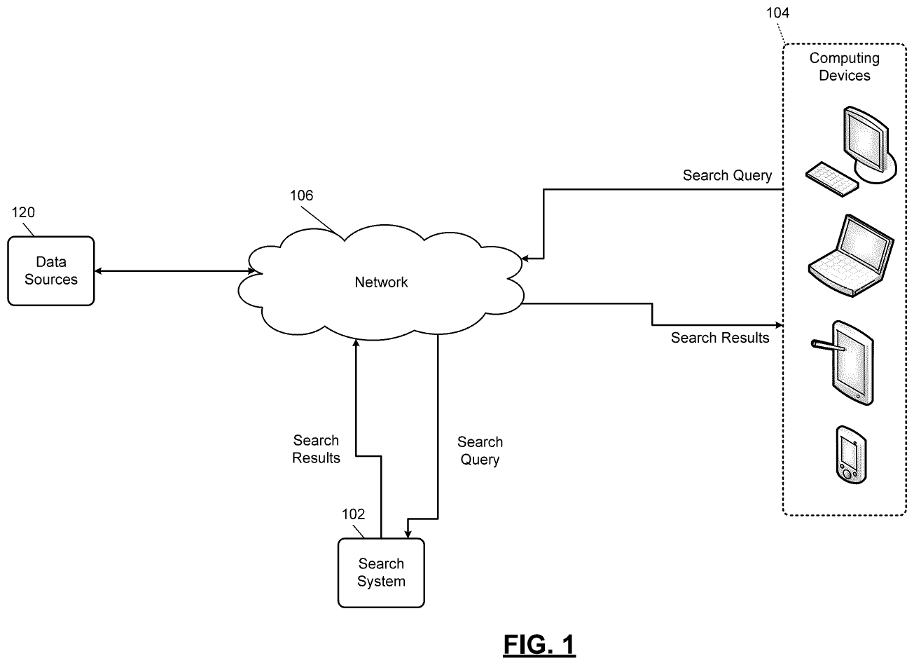

FIG. 1 includes a functional block diagram including a search system 102 configured to respond to queries. The search system 102 is configured to receive queries including images from one or more computing device(s) 104 via a network 106. The search system 102 performs searches for images based on the queries, respectively. The search system 102 transmits the search results back to the computing devices 104 that transmitted the queries, respectively.

The computing devices 104 may display the search results to users. The computing devices 104 may also display other information to the users. For example, the computing devices 104 may display additional information related to the search results, advertisements related to the search results, and/or other information. The search system 102 and the computing devices 104 communicate via a network 106.

A plurality of different types of computing devices 104 are illustrated in FIG. 1. The computing devices 104 include any type of computing devices that is configured to generate and transmit search queries to the search system 102 via the network 106. Examples of the computing devices 104 include, but are not limited to, smart (cellular) phones, tablet computers, laptop computers, and desktop computers, as illustrated in FIG. 1. The computing devices 104 may also include other computing devices having other form factors, such as computing devices included in vehicles, gaming devices, televisions, consoles (e.g., smart speakers without displays Amazon Echo, Google Home, Clova Friends mini) or other appliances (e.g., networked refrigerators, networked thermostats, etc.). In various implementations, the search system 102 may be implemented within or used with a device, such as a navigating robot or vehicle. Various uses for retrieved images include, for example, localization relative to an object in a captured image and other possible uses.

The computing devices 104 may use a variety of different operating systems. In an example where a computing device 104 is a mobile device, the computing device 104 may run an operating system including, but not limited to, Android, iOS developed by Apple Inc., or Windows Phone developed by Microsoft Corporation. In an example where a computing device 104 is a laptop or desktop device, the computing device 104 may run an operating system including, but not limited to, Microsoft Windows, Mac OS, or Linux. The computing devices 104 may also access the search system 102 while running operating systems other than those operating systems described above, whether presently available or developed in the future.

In some examples, a computing device 104 may communicate with the search system 102 using an application installed on the computing device 104. In general, a computing device 104 may communicate with the search system 102 using any application that can transmit queries to the search system 102 to be responded to (with search results) by the search system 102. In some examples, a computing device 104 may run an application that is dedicated to interfacing with the search system 102, such as an application dedicated to performing image searching and retrieval. In some examples, a computing device 104 may communicate with the search system 102 using a more general application, such as a web-browser application. The application executed by a computing device 104 to communicate with the search system 102 may receive search queries including images, respectively, via a camera of the computing device or stored in memory of the computing device 104.

A computing device 104 may receive a search result from the search system 102 that is responsive to the search query transmitted to the search system 102. In various implementations, the computing device 104 may receive and the search system 102 may transmit multiple search results that are responsive to the search query. In the example of the search system 102 providing multiple search results, the search system 102 may determine a confidence value (indicative of a likelihood of a search result is the most relevant search result to the search query) for each of the search results and provide the confidence values along with the search results to the computing device 104. The computing device 104 may display more than one of the multiple search results (e.g., all search results having a confidence value that is greater than a predetermined value), only the search result with the highest confidence value, the search results having the N highest confidence values (where N is an integer greater than one), etc.

The computing device 104 may be running (executing) an application including a GUI that displays the search result(s) received from the search system 102. The respective confidence value(s) may also be displayed. For example, the application used to transmit the search query to the search system 102 may also present (e.g., display or speak information on) the received search result(s) to the user via the computing device 104. As described above, the application that presents the received search result(s) to the user may be dedicated to interfacing with the search system 102 in some examples. In other examples, the application may be a more general application, such as a web-browser application.

The GUI of the application running on the computing device 104 may display the search result(s) to the user in a variety of different ways, depending on what information is transmitted to the computing device 104. In examples where the search results include a list of search results and associated confidence values, the search system 102 may transmit the list of search results and respective confidence values to the computing device 104. In this example, the GUI may display the search result(s) and the confidence value(s) to the user as a list of possible search results.

In some examples, the search system 102, or other computing system, may transmit additional information to the computing device 104 such as, but not limited to, applications and/or other information associated with the search results, the search query, or points of interest associated with the search results, etc. This additional information may be stored in a data store and transmitted by the search system 102 to the computing device 104 in some examples. In examples where the computing device 104 receives the additional information, the GUI may display the additional information along with the search result(s). In some examples, the GUI may display the search results as a list ordered from the top of the screen to the bottom of the screen by descending confidence value. In some examples, the search results may be displayed under the search field in which the user entered the search query.

In some examples, computing devices 104 may communicate with the search system 102 via a partner computing system. The partner computing system may include a computing system of a third party that may leverage the search functionality of the search system 102. The partner computing system may belong to a company or organization other than that which operates the search system 102. Example third parties which may leverage the functionality of the search system 102 may include, but are not limited to, internet search providers and wireless communications service providers. The computing devices 104 may send search queries to the search system 102 via the partner computing system. The computing devices 104 may also receive search results from the search system 102 via the partner computing system. The partner computing system may provide a user interface to the computing devices 104 in some examples and/or modify the user experience provided on the computing devices 104.

Data (e.g., images, text, audio, video, multi-modal data, etc.) regarding search results from which the search system 102 determines the search results for queries may be stored in one or more data sources 120. The data sources 120 may include a variety of different data providers. The data sources 120 may include digital distribution platforms such as, but are not limited to, online news sources, websites, social networking sites (e.g., Facebook, Twitter, etc.), databases, and/or other types of data sources.

In an example, the data sources 120 may include a plurality of images and associated captions, respectively. In other words, each image may have an associated (stored) caption. The images and the captions are stored in memory of one or more of the data sources 120.

The computing devices 104, the search system 102, and the data sources 120 may be in communication with one another via the network 106. The network 106 may include various types of networks, such as a wide area network (WAN) and/or the Internet. Although the network 106 may represent a long range network (e.g., Internet or WAN), in some implementations, the network 106 may include a shorter range network, such as a local area network (LAN). In one embodiment, the network 106 uses standard communications technologies and/or protocols. Thus, the network 106 can include links using technologies such as Ethernet, Wireless Fidelity (WiFi) (e.g., 802.11), worldwide interoperability for microwave access (WiMAX), 3G, 4G, 5G, Long Term Evolution (LTE), digital subscriber line (DSL), asynchronous transfer mode (ATM), InfiniBand, PCI Express Advanced Switching, etc. Similarly, the networking protocols used on the network 106 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 106 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In other examples, the network 106 can use custom and/or dedicated data communications technologies instead of, or in addition to, the ones described above.

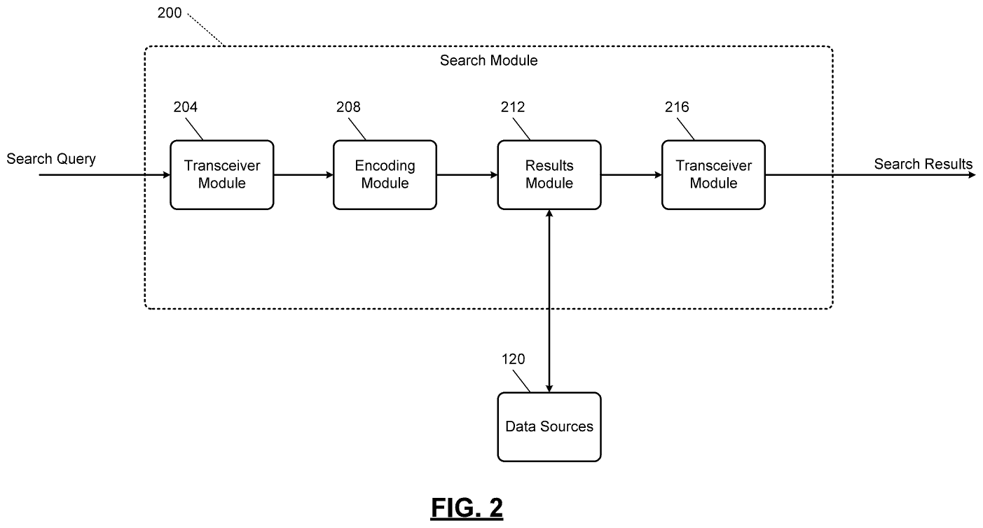

FIG. 2 is a functional block diagram including an example implementation of a search module 200 of the search system 102. A first transceiver module 204 receives a search query from a computing device 104, which in an example includes an image.

An encoding module 208 may encode the search query (e.g., a search query image) using one or more embedding functions. A results module 212 determines search results for the search query based on the data (e.g., the image) in the search query or the encoded output of the encoding module 208. The results module 212 determines the search results from the data sources 120 including images. The search results (e.g., images) may be encoded using the same embedding space, and the encodings may be stored in the data sources 120 or in another location. In an example, the results module 212 may determine the search results for the search query image as the N images of the data sources 120 that most closely match the search query image, where N is an integer greater than or equal to 1. The architecture of the results module 212 and training of the results module 212 is discussed further below. In various implementations, the data sources 120 may be stored within the search module 200 or within the same device as the search module 200.

A second transceiver module 216 transmits the determined search results (e.g., including images) for the search query back to the computing device 104 via the network 106. In various implementations, the second transceiver module 216 may be omitted, and the first transceiver module 204 may transmit the search results back to the computing device 104 from which the search query was received. For example, the search query may include N images. In various implementations, such as in the example of a navigating robot, the first and second transceivers 304 and 316 may be omitted.

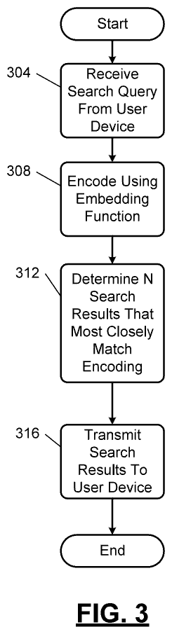

FIG. 3 includes a flowchart depicting an example method of receiving a search query and providing search results. The example of FIG. 3 may be performed by the search module 200.

Control begins with 304 where the search module 200 receives a search query, such as from a computing device 104. In an example, the search query includes an image.

At 308, the search module 200 may encode the search query using one of the embedding functions. At 312, the search module 200 determines the N images in the data sources 120 that most closely match the image of the search query or the encoding resulting from the search query. N is an integer greater than or equal to 1.

At 316, the search module 200 transmits the search results to the computing device 104 that transmitted the search query. The search results include the N images identified/retrieved that most closely match the image of the search query.

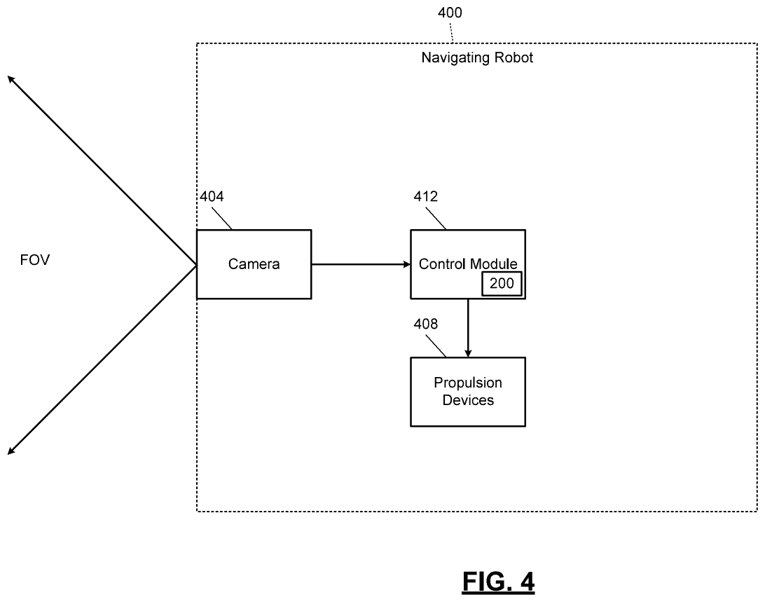

FIG. 4 is a functional block diagram of an example implementation of a navigating robot 400. The navigating robot 400 includes a camera 404 that captures images within a predetermined field of view (FOV), such as in front of the navigating robot 400. The predetermined FOV may be less than or equal to 360 degrees around the navigating robot 400. The navigating robot 400 may therefore have less than or equal to a full 360 degree FOV around the navigating robot 400. The operating environment of the navigating robot 400 may be an indoor space, i.e., within a building, parking garage, cave or other enclosure, or an outdoor space.

The camera 404 may be, for example, a grayscale camera, a grayscale—D camera, a red, green, blue (RGB) camera, an RGB-D camera, or another suitable type of camera. A grayscale-D camera includes a depth (D) component. An RGB-D camera also includes a depth (D) component. In various implementations, the navigating robot 400 may include only the (one) camera 404 and not include any other visual imaging cameras and/or sensors. Alternatively, the navigating robot 400 may include one or more other cameras and/or one or more other types of sensors.

The navigating robot 400 includes one or more propulsion devices 408, such as one or more wheels, one or more treads, one or more moving legs, and/or one or more other types of devices configured to propel the navigating robot 400 forward, right, left, up and/or down. A combination of two or more of the propulsion devices 408 may be used to propel the navigating robot 400 forward, to turn the navigating robot 400 right, to turn the navigating robot 400 left, and/or to elevate the navigating robot 400 vertically up or down.

The navigating robot 400 includes a control module 412 that is configured to control the propulsion devices 408 to navigate the operating environment, such as from a starting location to a goal location, without colliding with any objects based on input from the camera 404 and using the search module 200 as trained and described herein for image retrieval (e.g., for localization). An image dataset may be stored in memory of the navigating robot 400.

The camera 404 may update at a predetermined frequency, such as 60 hertz (Hz), 120 Hz, or another suitable frequency. The search module 200 may be used in an example to identify a closest image to an image from the camera 404, for example, to determine a present location of the navigating robot 400 or to identify an object in the field of view of the navigating robot 400. The control module 412 may control the propulsion devices 408 based on the present location of the navigating robot 400. For example, the control module 412 may actuate the propulsion devices 408 to move the navigating robot 400 forward by a predetermined distance based on the present location. The control module 412 may actuate the propulsion devices 408 to turn the navigating robot 400 to the right by a predetermined angle based on the present location. The control module 412 may actuate the propulsion devices 408 to turn the navigating robot 400 to the left by a predetermined angle based on the present location. The control module 412 may not actuate the propulsion devices 408 to not move the navigating robot 400 based on the present location. While example movements are provided, other movements are also possible.

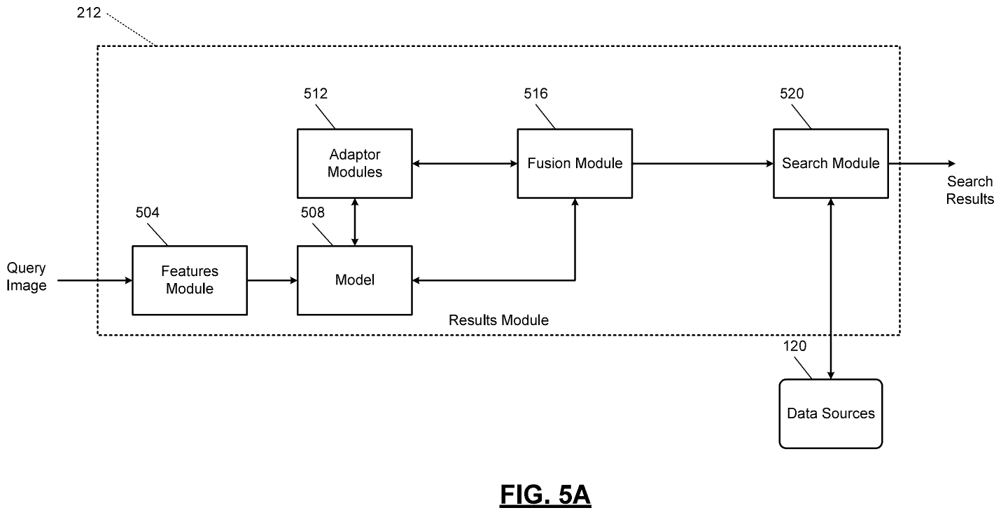

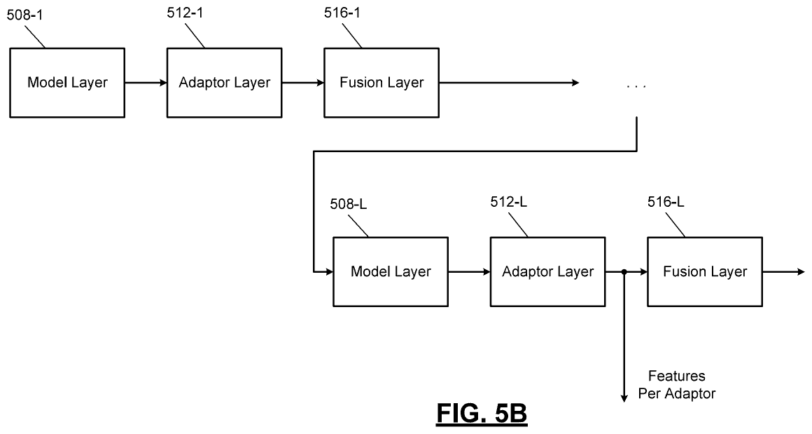

FIG. 5A and 5B are functional block diagrams of an example implementation of results module 212. A features module 504 in an example receives a query including an image (a query image). The features module 504 generates one or more feature vectors or matrices based on the query image. For example, the feature module 504 may divide the query image into a predetermined grid (e.g., 16×16) of squares. Each square may be processed by one or more layers, such as one or more convolutional layers, to generate an entry of the feature matrix or vector (h^{l-1}). The query image includes a patch size of P×P pixels, where P is an integer greater than or equal to 128. The features module 504 reshapes the input image x∈ [symbol] into a sequence of T flattened 2D patches where T=HW/P².

A model 508 processes the feature matrix or vector and outputs a result to adaptor modules 512. The model 508 may include the transformer architecture. The model may include a visual transformer (ViT) model. The transformer architecture is described in U.S. Pat. No. 10,452,978, which is incorporated herein in its entirety. The transformer architecture is also described in Ashish Vaswani, Noam Shazeer, Niki Parmar, Jakob Uszkoreit, Llion Jones, Aidan N Gomez, [symbol] ukasz Kaiser, and Illia Polosukhin, “Attention is all you need”, In I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety. The model 508 ( [symbol] ) may have the architecture described in A. Dosovitskiy, et al., An Image is Worth 16×16 Words: Transformers for Image Recognition at Scale, Proc. ICLR, 2021, which is incorporated herein in its entirety. The model 508 may be pretrained in a self-supervised manner using the DINO training described in M. Caron, et al., Emerging properties in Self-Supervised Vision Transformers, Proc. ICCV, 2021, which is incorporated herein in its entirety. The model 508 uses constant latent vector size D through all of its layers, so flattened patches are first mapped to D dimensions with a linear projection and a concatenated in h⁰ together with a prepended (e.g., learnable class) token and added position embeddings. The transformer encoder of the model 508 includes alternating blocks of multi headed self attention (MSA) and multi-layer perceptron (MLP) modules (which include 2 layers with Gaussian Error Linear Units (GELUs) with non-linearity). Layer normalization (LayerNorm (LN)) may be applied before each block/layer and residual connections may be provided after every block. In various implementations (e.g., if the model 508 includes a convolutional neural network), the model 508 may include the features module 504.

Stated formally, each layer of [symbol] may be given by:

h^{l}=MLP(LN(\tilde{h}^{l}))+\tilde{h}^{l},

\tilde{h}^{l}=MSA(LN(h^{l-1}))+\tilde{h}^{l-1}

for l={1, . . . , L}. The query image representation z may be the output of the [class] token for the last layer of h^{L}, z=LN(h^{L})[class]. The term classes may be used to refer to sets of images with the same label whether the latter represents object instances or fine-grained classes. The (pretrained) model 508 is kept fixed and not updated during the training discussed below.

Outputs of each layer of the model 508 are input to respective adaptor modules 512. The adaptor modules 512 may each have the transformer architecture. The results module 212 includes L adaptor modules 512 where L is an integer greater than 1, one adaptor module receiving the output of each transformer layer of the model 508.

A training dataset may be used that can be encoded with a pretrained model and encoded in a feature space. Assuming N sets of clusters each of a variable number of clusters k₁ to k_{N} and produced via a clustering algorithm, and each partitioning the feature space in partitions of different sizes. Encoding the training set features with such clusterings provides N pseudo-labels, i.e., corresponding clusters for each of the N clusterings per training set feature.

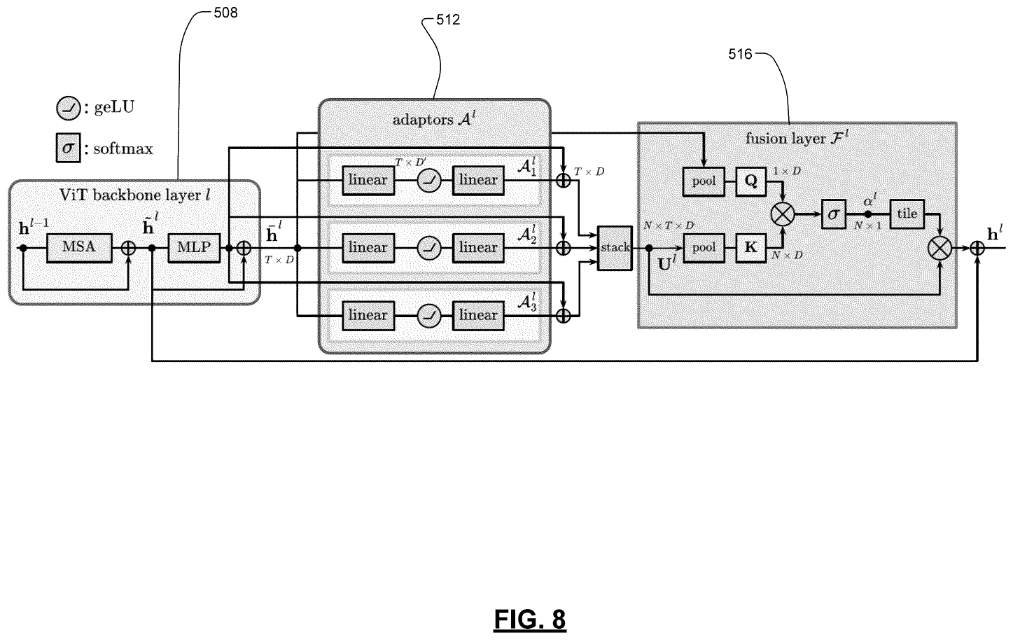

A set of adaptor modules [symbol] ᵢ is learned that corresponds to each pseudo-label set [symbol] ᵢ=i{1, . . . N}, respectively. Pseudo-labels may not include textual labels but instead include vector or matrix representations corresponding to textual labels. Each adaptor module 512 in the set of adaptor modules [symbol] ᵢ includes L adaptors denoted [symbol] , . . . [symbol] . The L adaptors may include bottleneck layers with an intermediate dimensionality of D′ where D′<D, a GELU layer between, and a residual connection at the end. An example architecture is shown in FIG. 8.

The architecture of the model 508 is modified by interleaving the model 508 with other modules. The output of layer l in the model 508 [symbol] will now be denoted and defined as h̅^{l}=MLP(LN(\tilde{h}^{l}))+\tilde{h}^{l}). The output of layer l (the output of the combination of the model 508 and the adaptor module) will be referred to as h^{l}.

A fusion module 516 fuses together (and combines) the outputs of the adaptor modules 512. In various implementations, the fusion module 516 may be omitted. An example architecture of the fusion module 516 is shown in FIG. 8.

Each of the N sets of adaptors is tailored to a different pseudo-granularity (referred to hereafter simply as granularity). The adaptors are unified into a signal architecture by appending (stacking) the N adaptors for each layer in parallel, as illustrated in the example of FIG. 8. The fusion module 516 may concatenate (stack in FIG. 8) the adaptor outputs into a tensor U^{l}∈ [symbol] for each layer l={1, . . . , L} where each row corresponds to the output of one adaptor for that layer. The fusion module 516 may also include another residual connection which allows the model 508 to bypass the adaptor if needed. The tensor U^{l} may be expressed as U^{l}={Aᵢ^{l}, (h̅^{l})+MLP(LN(\tilde{h}^{l})), i=1, . . . , N} and is fed with h̅^{l} (the output of the adaptor modules 508) to the fusion module 512. In various implementations, such as illustrated in the example of FIG. 8, the concatenation and generation of the tensor may be external to the fusion module 512.

As an example, the fusion module 516 may fuse the outputs of the N adaptors together by treating them as equally important and averaging the outputs of the N adaptor modules 512. In this example, the fusion module 516 serves as an average pooling layer that receives the tensor as input and determines a mean over its first dimension.

As another example, the fusion module 516 may fuse the outputs of the N adaptors together in another manner. Different retrieval tasks may be more related to certain granularities and therefore more suited for the corresponding adaptor modules 512. The fusion module 516 may therefore include different trainable parameters that can be trained and set to weight different adaptor module outputs. For example, the fusion module 516 may have a dot product self attention (transformer) architecture over the sequence of N adaptor outputs. Different than the query, key, value self attention, image level attention may be used by averaging over T spatial tokens and, to fuse the adaptor modules but not altering the adaptor module representations, the linear projection of the value portion may be omitted and projections for the query ad key branches that affect the re-weighting of the adaptor features only may be used. More specifically, the fusion module 516 may learn an attention vector of size N over the adaptor module 512 outputs given inputs h̅^{l} and U^{l} by [symbol] (h̅^{l}, U^{l})=α^{l}(h̅^{l}, U^{l})U^{l} where vector α^{l}(h̅^{l}, U^{l})∈ [symbol] is given by

$${α}^{l} ( {\overline{h}}^{l} , {U}^{l} ) = softmax ( \frac{( Q {Σ}_{T} {\overline{h}}^{l} ) ( K {Σ}_{T} {U}^{l} )}{\sqrt{D}} )$$

where Q is the query linear projection and K is the key linear projection, Q and K are size Dodd, and l={1, . . . , L}. A final residual connection may also be included in the fusion module 516 as illustrated in the example of FIG. 8. As illustrated in FIG. 8, the model 508, the adaptor modules 512, and the fusion module 516 may be appended in a residual fashion.

A search module 520 determines the closest one or more images to the query image from the data sources 120 based on the output of the fusion module 516 (or the outputs of the adaptor modules 512 if the fusion module 516 is omitted). The search module 520 provides the closest one or more images as the search results.

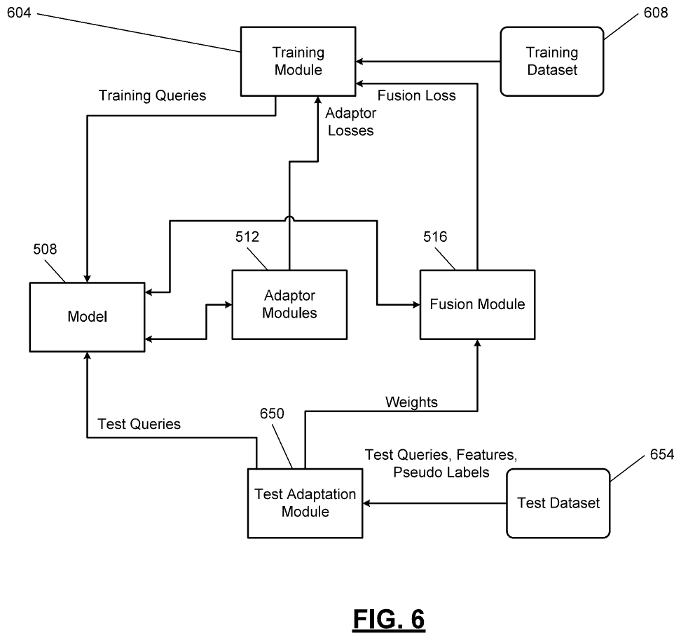

The adaptor and fusion modules 512 and 516 may be in parallel with the model 508, such as illustrated in FIG. 8 and FIG. 5B. For example, if the model 508 includes 12 layers/blocks, an adaptor and fusion layer/module 512 and 516 would be included after each layer/block of the model 508. As illustrated in FIG. 5B, L layers of the model 508, L adaptor module layers, and L fusion module layers are provided. L may be, for example, 12 or another suitable integer greater than 1. During test time adaptation discussed further below with reference to FIG. 6, the output of the last one of the L adaptor module layers (which may be referred to as features per adaptor or per adaptor features) may form part of test dataset 654 to be used by a test adaptation module 650 to adjust weights of the layers of the fusion module 516. Testing (the test time) may be performed after the training.

Only one fusion layer l is illustrated in the example of FIG. 8. Fusion layer l+1 follows fusion layer l. Each fusion layer may include a predetermined number of layers, such as 12-15 layers or another suitable number of layers. The output of each fusion layer is a matrix having the same dimensions as the input image.

An optional test-time fusion process can be performed at test/search time. Pseudo-labels for every image in the test dataset (e.g., the data sources 120) may have been determined or computed (e.g., also for the training set) and stored.

During test-time, the test adaptation module 650 shown in FIG. 6 may begin with the averaged training of the fusion module 516 (that is a fusion layer that simply averages all L adaptor outputs and has no learnable weights). The test adaptation module 650 feeds test images from the test dataset 654 into the trained results module 212. The test adaptation module 650 selectively adapts one or more weights of the fusion module 516 based on the search results generated based on one or more of the test images, such as based on a weighted averaging using per-adaptor weights computed for each query separately. The test adaptation module 650 may determine the weights, for example, based on the top K closest search results determined based on the test images. For example, the test adaptation module 650 may determine weights to be applied by the layers of the fusion module 516 for the respective layers of the adaptor module 512 based on the top K search results. The test adaptation module 650 may determine the weights, for example, based on statistics of agreement between the pseudo-labels of the top K results, such as pairwise agreement for all pairs of top K search results. A pair may be indicated as being in agreement with score n when n of the N pseudo-labels of the pairs are the same. A histogram where scores are aggregated over all pairs among the top K results can be generated by the test adaptation module 650 and used to determine the weights. For example, the test adaptation module 650 may set the weights to increase the weights in the fusion module for adaptor modules of more fine grained clusterings when more pseudo-labels are in agreement and vice versa. In various implementations, the test adaptation module 650 may select P number of the layers of the adaptor module 512 for use by setting the weights of the fusion module 516 to non-zero weight values while setting the weights for all of the other layers of the adaptor module 512 to zero where P is an integer greater than or equal to 1.

Another option for test-time fusion module adaptation is for the test adaptation module 650 to measure the statistics of agreement after N test queries where N is an integer greater than 1, with N separate features from the N adaptors (the per adaptor features or features per adaptor). The test adaptation module 560 may obtain these features from the output of the L-th (last) adaptor layer before the L-th (last) fusion module layer.

FIG. 6 is a functional block diagram of an example training system. A training module 604 is configured to train the adaptor modules 512 and the fusion module 516 using training data stored in a training dataset 608. The training module 604 leaves the model 508 unchanged (fixed) and does not train the model 508.

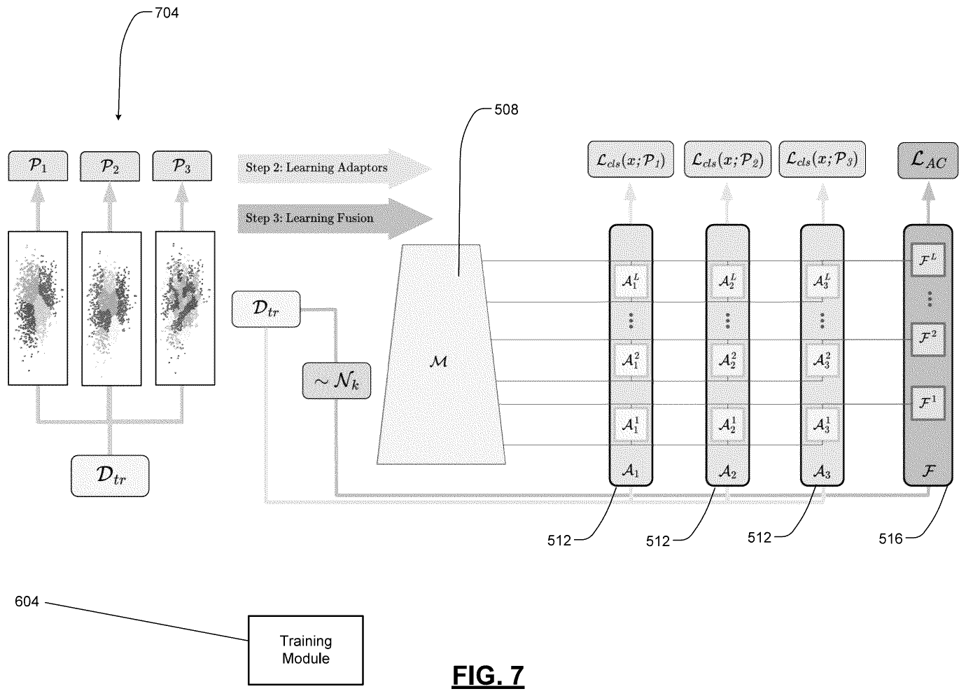

The training module 604 trains the adaptor modules 512 and the fusion module 516 such that multiple different image retrieval tasks (in different domains) can be performed by the results module 212 including tasks not included in the training dataset 608. The training module 604 trains the adaptor modules 512 and the fusion module 516 in an unsupervised manner using training dataset D. FIG. 7 is also a functional block diagram of the example training system.

First, the training module 604 learns multiple sets of pseudo-labels [symbol] for training images in the training dataset 608. As described above, the pseudo-labels are not actual labels for the content of the images but instead are representations of possible labels for the content of the images. Each set of pseudo-labels partitions the feature space into a different size using clustering (of different sizes) and corresponds to a specific level of granularity. This is illustrated by 704 in FIG. 7. The training module 604 may partition the feature space (the training dataset) and cluster training samples, for example, using k-means clustering. As illustrated in FIG. 7, on the left, the clusters of pseudo-labels [symbol] ₁ and [symbol] ₂ are larger and thus less granular than pseudo-label [symbol] ₃. In the middle, the clusters of pseudo-label [symbol] ₂ are smaller than on the left and thus more granular. On the right, the clusters of pseudo-label [symbol] ₁ are smaller than the clusters of pseudo-label [symbol] ₂ in the middle and thus more granular.

Second, the training module 604 trains the adaptor modules 512 specific to each level of granularity to minimize a loss, such as a classification loss ( [symbol] _{cls}), also referred to as adaptor losses, based on differences between the learned pseudo-labels [symbol] for the training samples and outputs of the adaptor modules 512 based on the training samples. This is illustrated by the green arrows in FIG. 7.

Third, the training module 604 trains the fusion module 516 (e.g., a set of layers of the fusion module 516) to merge/fuse the outputs of the adaptor modules 512, for example, to minimize a transformation invariance or a loss, such as an attention propagation loss. This is illustrated by the blue arrows/lines in FIG. 7.

The three stages of the training yields a model denoted as [symbol] that involves multiple different granularities and includes the pretrained model 508 used as a frozen backbone (its parameters are kept fixed during the training), the trained embedded adaptor modules 512 [symbol] ᵢ and the trained fusion module 516 [symbol] . This model [symbol] performs as a feature extractor for all different image retrieval tasks including tasks not included in the training dataset.

Regarding the first stage and learning the pseudo-labels, a goal for the training module 604 shown FIG. 6 is to generate multiple sets of pseudo-labels [symbol] ᵢ such that they partition the feature space [symbol] ₜᵣ at different granularities as shown at 704 in FIG. 7. The training module 604 may approximate the partitioning by estimating multiple sets of clusters while varying the number of centers.

For example, the training module 604 may extract features using the model [symbol] . Let z=f(x; [symbol] ) be the feature of an image x∈ [symbol] . Let the set of all features for training set [symbol] be [symbol] ={f(x; [symbol] ), ∀x∈ [symbol] }. To generate multiple sets of pseudo-labels, the training module 604 may cluster the full set of features [symbol] into sets of centroids [symbol] ᵢ, i=1, . . . , N of respectively kᵢ clusters where kᵢ gets monotonically larger as i approaches N. This produces N sets of pseudo-labels [symbol] ₁, . . . , [symbol] _{N}. For each pseudo label set [symbol] ᵢ, an image x∈ [symbol] is associated with a pseudo label given by [symbol] ᵢ(x)=argmin_{c∈C}_{ᵢ}∥z−c∥ for z=ƒ(x; [symbol] ). k-means clustering with k-means++ initialization may be used by the training module 604 or another suitable type of k-means clustering. While the example of k-means clustering is referenced, the present application is also applicable to other ways of learning multiple sets and using all of the learned sets. k-means clustering is described in S. Lloyd, et al., Least Squares Quantization in PCM, TIT 28(2), 129-137, 1982), which is incorporated herein in its entirety. k-means++ is described in D. Arthur, et al., k-means++ the Advantages of Careful Seeding, Tech. Rep. Stanford (2006), which is incorporated herein in its entirety.

Regarding the second stage of the training involving training the adaptor modules 512 for each pseudo-label set, given the N sets of pseudo-labels computed via the first stage, the training module trains the adaptor modules 512 to each pseudo-label set, i.e., to each different level of granularity. The pretrained model 508 is used as a backbone and extended by embedding an adaptor module at every layer. The training module 604 trains the adaptor module parameters while keeping the model 508 frozen. The training module 604 learns a set of L adaptors (for each adaptor module 512) for each level of granularity independently by minimizing the adaptor losses, respectively.

Given a set of pseudo-labels [symbol] ᵢ, the training module 604 can learn parameters of each adaptor module 512 in the set of adaptor modules Aᵢ, for example based on minimizing a supervised cross entropy loss. For example, a norm-softmax loss may be used that, for image x, may be given by

$${ℒ}_{CLS} ( x ; y ) = log \frac{exp ( γ cos {θ}_{γ} )}{{\sum }_{{y}^{′} = 1}^{{k}_{i}} exp ( γ cos {θ}_{{γ}^{′}} )}$$

where γ is a scalar factor/value, cosθ_{γ} is the cosine similarity to the classifier of class y, and the loss is guided by the pseudo-labels, y= [symbol] ᵢ(x). After training the parameters for each set [symbol] ᵢ, the adaptors may be kept and the classifiers may be omitted.

The third stage of the training is discussed above and involves training the fusion module 516 parameters. Average pooling or the other types of training above may be used by the training module 604.

Given the model [symbol] 508 (pretrained) and multiple sets of adaptor modules 512, one way to construct the model [symbol] would be to select one set of adaptor parameters per image. This, however, may be similar to guessing which level of granularity best fits each image. In a visual search system for performing multiple different tasks (e.g., image searching for boats, image searching for dogs, image searching for birds, etc.) depends less on the content of the query image than on the task (i.e., the dataset selected from). For example, given a query image including a dog, a way to know if the query is looking for any dog image or only images of the same dog breed is to look at the local structure of the dataset around that image. Both scenarios might favor different representations. The model [symbol] (the results module 212) described herein reconciles them by learning a combination of adaptor modules 512. The training dataset 608 includes an unlabeled set of images [symbol] (i.e., images without stored labels/classifications) that are representative of the target image retrieval tasks and/or a target granularity. The training images are stored without task labels, so which retrieval task they correspond to is unknown during the training.

Without supervision (and without any supervisory signal), the local neighborhood in the feature space of the training dataset [symbol] can be used to approximate the granularity of a query image. Visually similar images from the training dataset [symbol] should yield similar attention vectors over the set of adaptor modules 512. The training module 604 therefore trains the fusion module 516 based on minimizing a loss on neighboring pairs of images in the feature space. In this portion, the model 508 and the adaptor modules 512 are maintained fixed by the training module 604. The training module 604 only learns K and Q which are two linear projections that are multiplied to give the attention vectors α^{l} for each (e.g., ViT) encoder I. This may mean that the fusion stage only involves the training module 604 reweighting adaptor features of the fusion module 516. The final model, including the model 508 with the trained adaptor modules 512 and the trained fusion module 516 can be denoted [symbol] and the feature extractor (e.g., of feature module 504) as ƒ*(x, [symbol] ).

Regarding attention propagation loss, the training module 604 may train the fusion module 516 leveraging the idea that neighboring image pairs in the feature space should use similar attentions over the adaptor modules 512. Let [symbol] (x; [symbol] ) (see FIG. 7) denote the nearest k neighbors of x from dataset [symbol] . The training module 604 determines the nearest k neighbors to a training image from the training dataset 608.

Neighbors (xᵢ, xⱼ) are a pair of input such that xⱼ∈ [symbol] (xᵢ; [symbol] ). While neighbors could be determined using the pretrained model z=ƒ(x, [symbol] ) (e.g., a static K neural network (NN)), the representations \tilde{z}=ƒ*(x, [symbol] ) from the model [symbol] may provide better estimations. The training module 604 may periodically update neighbors during the training, such at each epoch. Given a pair of neighboring features, the training module 604 brings the adaptor attentions close to each other based on attention consistency ( [symbol] _{AC}).

The training module 604 may achieve attention consistency, such as using a pairwise Barlow Twins loss, such as described in J. Zbontar, et al., Barlow Twins: Self-Supervised Learning via Redundancy Reduction, in Proc. ICML, 2021. Given a batch of image pairs, the loss may be defined over the output representations \tilde{z}ₗ=ƒ*(xᵢ, [symbol] ), \tilde{z}ⱼ=ƒ*(xⱼ, [symbol] ) from the model [symbol] determined over the D×D cross-correlation matrix C and averages over the batch, such as defined by

$${ℒ}_{BT} = {\sum }_{n} {( 1 - {c}^{nn} )}^{2} + β {\sum }_{n} {\sum }_{m \neq n} {( {C}^{nn} )}^{2} , \\ {C}^{nn} = \frac{{Σ}_{b} {g ( \hat{{z}_{i}} )}^{b , n} {g ( \hat{{z}_{j}} )}^{b , m}}{\sqrt{{Σ}_{b} {( {g ( \hat{{z}_{i}} )}^{b , n} )}^{2}} \sqrt{{( {g ( \hat{{z}_{j}} )}^{b , m} )}^{2}}}$$

where b iterates over pairs in the bath, n and m iterate over feature dimensions, β is a hyerparameter, and g(⋅) is a MLP projector appended to the model and not used after the training. The loss may be defined over two transformed versions of the same image (xᵢ and xⱼ). When image pairs are created using image transformations, the above equation may define a transformation consistency (TC) loss or [symbol] _{TC}. The training module 604 applies this loss on neighboring pairs in the feature space (xᵢ, xⱼ) such as xⱼ∈ [symbol] (xᵢ; [symbol] ) and using it for attention propagation. The training module may execute the TLDR method described in Y., Kalantidis, et al., TLDR: Twin Learning for Dimensionality Reduction, TMLR, 2022, which uses the Barlow Twins loss over neighbor pairs for learning a feature encoder for dimensionality reduction. The training module 604 may use the Barlow Twins loss on image pairs defined using the k-NN graph. This loss may denoted as the attention consistency (AC) loss [symbol] _{AC}.

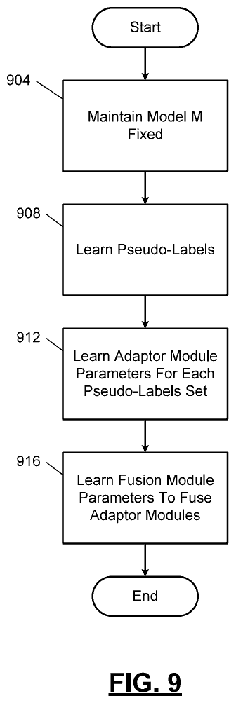

FIG. 9 is a flowchart depicting an example method of training the results module 212. Control begins with 904 where the training module 604 fixes (parameters and architecture of) the model 508. At 908, the training module 604 determines pseudo-label sets for the training images, respectively, in the training dataset 608. For example, the training module 604 may generate N=8 sets of pseudo-labels including 256, 1024, 4,096, 8,192, 16,384, 32,768, 65,356, and 131,072 clusters.

At 912, the training module 604 trains/learns the parameters of the sets of the adaptor modules 512 based on the pseudo-label sets, respectively, such a based on minimizing a classification loss. The training module 604 may learn a set of adaptors for each pseudo-label set, such as using the norm-softmax loss from the above equation involving [symbol] _{CLS}. In various implementations, the training module 604 may use the Adam optimizer with a learning rate and weight decay of 0.01.

At 916, the training module 604 maintains the parameters of the adaptor modules 512 and trains the parameters of the fusion module 516 based on the outputs of the adaptor modules 512, such as based on minimizing a transformation invariance or an attention propagation loss. In various implementations, the training module 604 may use the Barlow Twins loss and the LARS optimizer. In an example, a learning rate and weight decay of 0.5 and 0.001, respectively, may be used.

After 916, the training is complete and the results module 212 (including the model 508, the adaptor modules 512, and the fusion module 516) can be used to perform image retrieval in multiple different tasks.

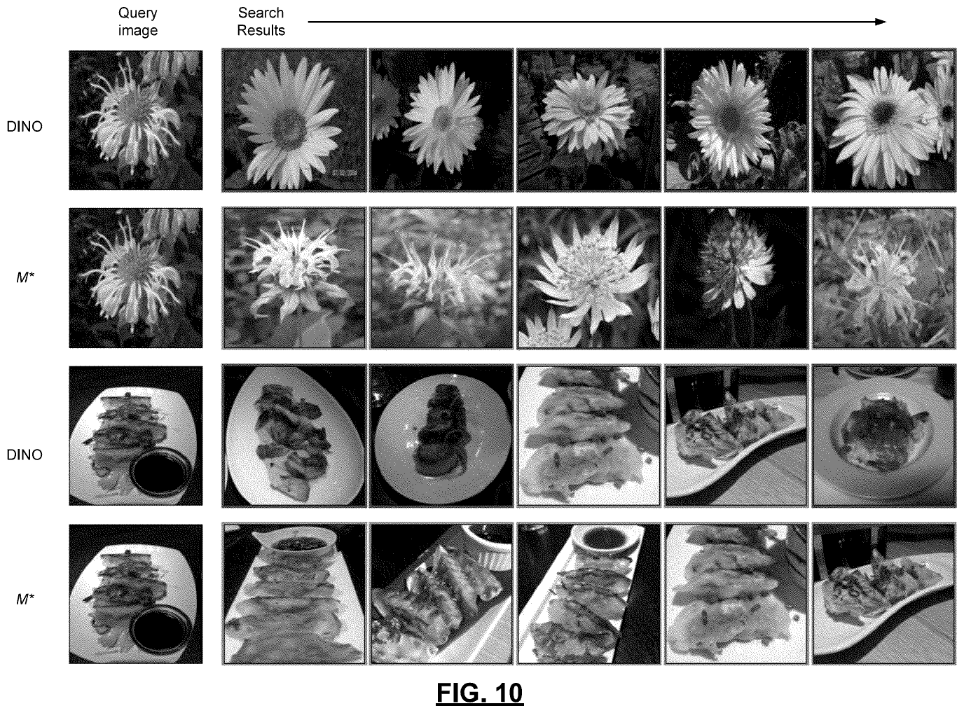

FIG. 10 illustrates two different query images being input to the model of the present application [symbol] and a different model (DINO) and search results from the two different models. FIG. 10 illustrates that the model architected and trained as described herein perform better than the other (different) model.

Regarding FIG. 5B, the test time adaptation process may involve querying where after querying with one adapted model, the pseudo-labels of the top results are used by the training module 604 adjusts weights of the adaptor modules and a second query, now with re-weighted adaptor modules is generated. In various implementations, the test-time adaptation process is performed by the training module 604 after retrieving the top search results using a model that includes a set of adaptors modules.

In various implementations, the model uses average fusion over the set of adaptor modules. In various implementations, the test-time adaptation process involves the training module 604 determining weights per adaptor module based on the top retrieved results, and a second query is subsequently performed by weighing the contribution of each adaptors modules by the computed weights. In various implementations, the training module 604 determines the weights as a function of the pseudo labels of the top search results. In various implementations, the function is based on a histogram of the number of pseudo-labels that agree between all possible pairs among the top search results.

In various implementations, the test-time adaptation process is used for selecting only one or more adaptor modules by the training module 604. In various implementations, the test-time adaptation process is performed by the training module 604 based on multiple top search result lists, each one obtained by querying with per-adaptor features. In various implementations, the per-adaptor features are obtained by the training module 604 from each adaptor feature after the last layer and before the last fusion layer.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An information retrieval training system, comprising:
a training dataset including training data having a feature space; the training data including multiple different types of elements, wherein no labels are provided with the training data;
a training module configured to:
maintain fixed a pre-trained model configured to receive features of queries;
learn sets of pseudo-labels based on the training data;
train parameters of adaptor modules for each of the sets of pseudo-labels, respectively, the adaptor modules configured to receive outputs of the pre-trained model, respectively; and
train parameters of fusion modules based on neighboring pairs of the training data, the fusion modules configured to fuse together outputs of the adaptor modules, respectively.

2. The information retrieval training system of claim 1 wherein the training module is configured to train the parameters of the fusion modules after training the parameters of the adaptor modules.

3. The information retrieval training system of claim 1 wherein the adaptor modules are appended to layers, respectively, of the pre-trained model.

4. The information retrieval training system of claim 1 wherein the pre-trained model has the transformer architecture.

5. The information retrieval training system of claim 1 wherein the pre-trained model includes a convolutional neural network.

6. The information retrieval training system of claim 1 wherein the pre-trained model includes multiple layers, each layer including a multi head self attention (MSA) module and a multi layer perceptron (MLP) module.

7. The information retrieval training system of claim 1 wherein the adaptor modules each include a gaussian error linear unit (geLU) and a multi layer perceptron (MLP) module.

8. The information retrieval training system of claim 1 wherein the fusion modules each include an average pooling module that averages the outputs of the adaptor modules.

9. The information retrieval training system of claim 1 wherein the training module is configured to determine the sets of pseudo-labels using k-means clustering.

10. The information retrieval training system of claim 9 wherein the training module configured to determine the sets of pseudo-labels based on clustering a set of features of the training data into centroids.

11. The information retrieval training system of claim 1 wherein the training module is configured to train the parameters of the adaptor modules based on minimizing a norm softmax loss.

12. The information retrieval training system of claim 1 wherein the training module is configured to train the parameters of the fusion modules based on minimizing a Barlow Twins loss.

13. The information retrieval training system of claim 1 further comprising a test adaptation module configured to selectively adjust weights of the fusion modules based on search results determined based on the model, the fusion modules, and the adaptor modules based on test data.

14. The information retrieval training system of claim 13 wherein the test adaptation module is configured to selectively adjust the weights of the fusion modules based on a closest k number the search results to the test data, where k is an integer greater than one.

15. The information retrieval training system of claim 14 wherein the test adaptation module is configured to set the weights of the fusion modules based on pseudo-labels for the closest k number of the search results.

16. The information retrieval training system of claim 14 wherein the test adaptation module is configured to set the weights of the fusion modules based on determinations of whether the pseudo-labels of pairs of the search results in the closest k number of the search results are the same.

17. The information retrieval training system of claim 13 wherein the test adaptation module is configured to set the weights of the fusion modules based on features determined by a last one of the adaptation modules and input to a last one of the fusion modules.

18. The information retrieval training system of claim 13 wherein the test adaptation module is configured to set the weights of P number of the fusion modules to non-zero values, where P is an integer greater than or equal to one, and to set the weights of the remainder of the fusion modules to zero.

19. The information retrieval training system of claim 13 wherein the pseudo-labels partition the feature space at different levels of pseudo-granularity, each partition of the feature space corresponding to a different set of pseudo-labels in the sets of pseudo-labels, and each adaptor module corresponding to one of the different levels of pseudo-granularity.

20. The information retrieval training system of claim 19 wherein the training data is image training data, the queries are query images, the test data is a test image, the elements of training data are objects of image training data.

21. An information retrieval system, comprising:
a features module configured to receive a query and generate features based on the query;
a model configured to generate model outputs based on the features, respectively;
adaptor modules configured to generate adaptor module outputs based on the model outputs, respectively, the adaptor modules including parameters trained based on sets of pseudo-labels determined based on unlabeled training data having a feature space;
a fusion module configured to generate a fusion module output based on the adaptor module outputs, the fusion module including parameters trained based on neighboring pairs of the training data; and
a search module configured to, based on the fusion module output, determine a closest one or more search results to the query.

22. The information retrieval system of claim 21 wherein the pseudo-labels partition the feature space at different levels of pseudo-granularity, each partition of the feature space corresponding to a different set of pseudo-labels in the sets of pseudo-labels, and each adaptor module corresponding to one of the different levels of pseudo-granularity.

23. The information retrieval system of claim 22 wherein the training data is image training data, the query is a query image and the search results include a closest one or more images to the query image.

24. An information retrieval method, comprising:
receiving a query;
generating features based on the query;
by a model, generating model outputs based on the features, respectively;
by adaptor modules including parameters trained based on sets of pseudo-labels determined based on unlabeled training data having a feature space, generating adaptor module outputs based on the model outputs, respectively;
by a fusion module including parameters trained based on neighboring pairs of the training data, generating a fusion module output based on the adaptor module outputs; and
based on the fusion module output, determining a closest one or more search results to the query.

25. The information retrieval method of claim 24 wherein the pseudo-labels partition the feature space at different levels of pseudo-granularity, each partition of the feature space corresponding to a different set of pseudo-labels in the sets of pseudo-labels, and each of the adaptor modules corresponding to one of the different levels of pseudo-granularity.

26. The information retrieval method of claim 25 wherein the training data is image training data, the query is a query image and the search results include a closest one or more images to the query image.
